(19) United States
(12) Patent Application Publication
(10) Pub. No.: US 2016/0171547 A1
(43) Pub. Date: Jun. 16, 2016

(54) METHOD AND SYSTEM FOR PROVIDING TARGETED ADVERTISING

(71) Applicant: Walkbase LTD, Turku (FI)

(72) Inventors: Björn Sjölund, Turku (FI); Niclas Jern, Turku (FI); Gabriel Nyman, Mariehamn (FI)

(21) Appl. No.: 14/966,081

(22) Filed: Dec. 11, 2015

Related U.S. Application Data
(60) Provisional application No. 62/090,933, filed on Dec. 12, 2014.

(51) Int. Cl. G06Q 30/02

(52) U.S. Cl. CPC G06Q 30/0261; G06Q 30/0264; G06Q 30/0273

(57) ABSTRACT

Disclosed are system and method for providing targeted advertising within a retail premises having a plurality of zones, each of the plurality of zones is associated with a retail context. The system and method comprise identifying spatial positions of portable communication devices associated with consumers in the retail premises and determining paths traversed by the portable communication devices within the retail premises by identifying sequences in which zones are visited by the portable communication devices. The identification of sequences is based on the spatial positions and dwell-time of the portable communication devices. The paths include retail contexts of the zones visited by the portable communication devices. Further, the system and method comprise selecting advertisement to be displayed, via at least one of a plurality of digital signages arranged in the retail premises, based on change in counter of the retail contexts of the paths.

### TECHNICAL FIELD

The present disclosure generally relates to managing advertisement displayed by digital signages, and more specifically, to a system and a method for providing targeted advertising within a retail premise having a plurality of zones.

### BACKGROUND

Advertisement is a primary tool for promoting sale of any product (or services). Further, in today's digital world a large segment of advertisement is presented digitally to attract consumers (customers or shoppers) for buying the advertised product. One such example includes digitally presenting advertisement to the shoppers of a retail premise, such as a shopping mall or a shopping centre, having number of zones generally associated with various products. Typically, the advertisement presented in such shopping complex includes a series of recorded video and/or audio content related to the various products available in the various zones. Further, such advertisement content is presented continuously in a loop and in a particular location in the shopping complex.

Although, the advertisement is presented continuously and dynamically (i.e. changing with time to display various products) but still conventional methods and systems for presenting advertisement are subjected to several shortcomings. For example, while presenting the advertisement content, the advertisement content is simply presented irrespective of shopping behavior of the shoppers present in the shopping complex. Further, consumers' response towards the presented advertisement content cannot be analyzed. Specifically, when, where and what advertisement content to be presented in the shopping complex such that consumer's response towards advertised product increases. Moreover, the pricing for the advertisement to be displayed with conventional methods and systems is based purely on estimated values, and irrespective of consumer's behavior.

Therefore, in light of the foregoing discussion, there exists a need to overcome the aforementioned drawbacks of presenting or displaying advertisement via digital signages in a shopping complex.

### SUMMARY

The present disclosure seeks to provide an improved method for providing targeted advertising within a retail premises having a plurality of zones.

The present disclosure also seeks to provide an improved system for providing targeted advertising within a retail premises having a plurality of zones.

In a first aspect, embodiments of the present disclosure provide a method for providing targeted advertising within a retail premises having a plurality of zones, each of the plurality of zones is associated with a retail context, the method comprising:
identifying spatial positions of portable communication devices associated with consumers in the retail premises;
determining paths traversed by the portable communication devices within the retail premises by identifying sequences in which zones are visited by the portable communication devices, wherein the identification of sequences is based on the spatial positions and dwell-time of the portable communication devices, and wherein the paths include retail contexts of the zones visited by the portable communication devices; and
selecting advertisement to be displayed, via at least one of a plurality of digital signages arranged in the retail premises, based on change in counter of the retail contexts of the paths.

In a second aspect, embodiments of the present disclosure provide a system for providing targeted advertising within a retail premises having a plurality of zones, each of the plurality of zones is associated with a retail context, the system comprising:
a plurality of digital signages arranged in the retail premises;
a plurality of wireless apparatuses for determining spatial positions of portable communication devices associated with consumers in the retail premises; and
a data processing arrangement operable to
determine paths traversed by the portable communication devices within the retail premises by identifying sequences in which zones are visited by the portable communication devices, wherein the identification of sequences is based on the spatial positions and dwell-time of the portable communication devices, and wherein the paths include retail contexts associated with the zones visited by the portable communication devices; and
select advertisement to be displayed, via at least one of the plurality of digital signages, based on change in counter of the retail contexts of the paths.

Embodiments of the present disclosure substantially eliminate or at least partially address the aforementioned problems in the prior art, and enable efficient targeted advertising.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIGS. 1, 2 and 3 are illustrations of an example retail premises that is suitable for practicing various embodiments of the present disclosure;

FIG. 4 is a schematic illustration of a system for providing targeted advertising within a retail premises, in accordance with an embodiment of the present disclosure;

FIG. 5 is a flow chart depicting steps of a method for determining a probable path for currently active customers present in a retail premises, in accordance with an embodiment of the present disclosure;

FIG. 6 is a schematic illustration of an example Application Programming Interface (API), in accordance with an embodiment of the present disclosure; and

FIG. 7 is an illustration of steps of a method for providing targeted advertising within a retail premises, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure has been disclosed, those skilled in the art would recognize that other embodiments for carrying out or practicing the present disclosure are also possible.

In a first aspect, embodiments of the present disclosure provide a method for providing targeted advertising within a retail premises having a plurality of zones, each of the plurality of zones is associated with a retail context. The method comprises:
identifying spatial positions of portable communication devices associated with consumers in the retail premises;
determining paths traversed by the portable communication devices within the retail premises by identifying sequences in which zones are visited by the portable communication devices, wherein the identification of sequences is based on the spatial positions and dwell-time of the portable communication devices, and wherein the paths include retail contexts of the zones visited by the portable communication devices; and
selecting advertisement to be displayed, via at least one of a plurality of digital signages arranged in the retail premises, based on change in counter of the retail contexts of the paths.

According to an embodiment, the counter of the retail contexts of the paths changes with subsequent visits of the portable communication devices to the zones in the retail premises.

In one embodiment, the method further comprises altering the advertisement based on the changed retail contexts of the paths of the portable communication devices in the retail premises.

According to an embodiment, the changed retail contexts of the paths provide a probable path for a maximum number of currently active portable communication devices in the retail premises.

In one embodiment, the counter comprises at least one of visiting frequencies and dwell-times of the portable communication devices.

In one embodiment, the retail contexts comprise one of a product category and a brand of a product.

According to an embodiment, the method further comprises adding new retail contexts to the paths based on new visits of the portable communication devices to new zones of the plurality of zones.

According to an embodiment, the targeted advertising is provided in real time.

According to an embodiment, the one or more behavior-specific metrics are collected anonymously.

According to an embodiment, the method further comprises determining price for selected advertisement to be displayed.

In one embodiment, based on the determined price a time period and a digital signage, present in the retail premises, is selected for displaying the selected advertisement.

In a second aspect, embodiments of the present disclosure provide a system for providing targeted advertising within a retail premises having a plurality of zones, each of the plurality of zones is associated with a retail context. The system comprises
a plurality of digital signages arranged in the retail premises;
a plurality of wireless apparatuses for determining spatial positions of portable communication devices associated with consumers in the retail premises; and
a data processing arrangement operable to
   determine paths traversed by the portable communication devices within the retail premises by identifying sequences in which zones are visited by the portable communication devices, wherein the identification of sequences is based on the spatial positions and dwell-time of the portable communication devices, and wherein the paths include retail contexts of the zones visited by the portable communication devices; and select advertisement to be displayed, via at least one of the plurality of digital signages, based on change in counter of the retail contexts of the paths.

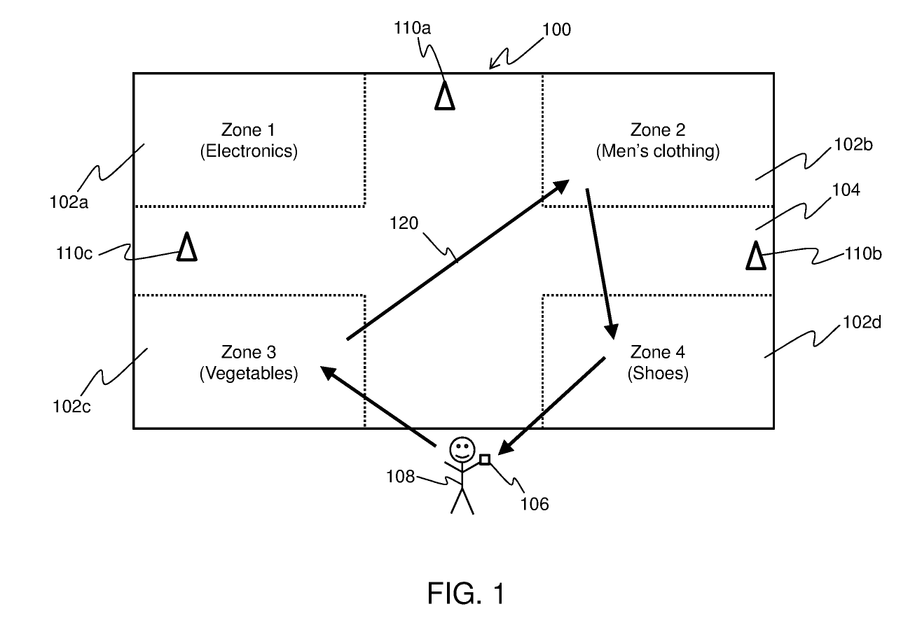

Referring now to the drawings, particularly, by their reference numbers, FIG. 1 is an illustration of an example retail premise 100 that is suitable for practicing various embodiments of the present disclosure. The retail premise 100 is partitioned into a plurality of zones. For discussion purposes, these zones are depicted as zones 102a, 102b, 102c and 102d (hereinafter collectively referred to as zones 102) along a hallway 104 in FIG. 1.

The zones 102 in the retail premises 100 are actual physical zones having physical boundaries. Further, each of the zones 102 is associated with a retail context. In an example, the context comprises a product category and a brand of a product. Specifically, the context is associated with products (or services) offered for sale by the shopping zones. For example, the products may include electronic goods, men and women apparels, groceries, toys and the like. Similarly, the services may include salon, game parlor, spa, massage centre and the like. Therefore, the context can be either name of the product or service, or the brand of the product or service. As shown, the zones 102a, 102b, 102c and 102d may be associated with retail contexts, such as “Electronics”, “Men's clothing”, “Vegetables” and “Shoes”, respectively.

Moreover, in order to enable tracking of portable communication devices carried by customers within the retail premises 100, the retail premises 100 is equipped with a wireless communication network. As shown, a portable communication device 106 associated with (or carried by) a customer 108 may be tracked by the wireless communication network.

In an example, the portable communication device 106 includes, but is not limited to, mobile phones, smart telephones, Mobile Internet Devices (MID's), tablet computers, Ultra-Mobile Personal Computers (UMPC's), phablet computers, Personal Digital Assistants (PDA's), web pads, and handheld Personal Computers (PC's).

Further, the wireless communication network is at least partially implemented by way of a plurality of wireless apparatus that are installed at specific locations within the retail premises. As shown, a plurality of wireless apparatuses, such as 110a, 110b and 110c (hereinafter collectively referred to as wireless apparatuses 110), are arranged in the retail premises 100. Examples of such wireless apparatuses include, but are not limited to, wireless routers for Wi-Fi communication, or Bluetooth base stations; “Bluetooth” is a registered trademark.

While the customer 108 move in and around the zones 102 and the hallway 104 within the retail premises 100, the corresponding portable communication device 106 communicates with the wireless apparatuses 110. An example of the communication is the portable communication device 106 sending probe requests to actively seek for an access point, as defined in IEEE 802.11 WLAN standard, and wireless apparatus 110 listening for such probe requests. The portable communication device 106 is provided with suitable hardware and/or software applications that support wireless communication, such as Wi-Fi and Bluetooth technology.

This technology will work for both anonymous WiFi tracking and Bluetooth (iBeacon®) tracking. The difference being that the anonymous WiFi data will only be useful when determining what kind of interests a majority of customers have in real time. However, for iBeacons the customer identity may be known and behavior of such customers may be associated with his identity. Therefore, targeted adverting may be provided to portable communication devices associated with such customers; and also to digital signages arranged in the retail premises when such consumers visit the retail premises.

Optionally, the portable communication device 106 may transmit its identification codes (ID) to the wireless apparatuses 110 on their own. Alternatively, optionally, the wireless apparatuses 110 may send a request for identification to the portable communication device 106, which may then transmit its ID to the wireless apparatuses 110.

The ID may, for example, be Media Access Control (MAC) address pertaining to the portable communication device 106. According to an embodiment, the ID of the portable communication device 106 may be permanent in nature (i.e. remains same for a same portable communication device). Additionally, the ID may include Terminal Identifier (TID), Service Set Identifier (SSID) or other identification pertaining to the portable communication devices.

Subsequently, the wireless apparatuses 110 are operable to transmit data pertaining to the portable communication device 106 to a data processing arrangement (not shown in FIG. 1, will be explained in greater detail with subsequent figures). The data pertaining to the portable communication devices may, for example, include Received Signal Strength Indication (RSSI) measurements or Time-of-Flight (ToF) measurements collected by the wireless apparatuses 110.

The data processing arrangement is then operable to determine spatial positions of the portable communication device 106, for example, by way of triangulation. It is to be noted here that the spatial positions of the portable communication devices (such as the device 106) can be determined by other suitable methods, without departing from the scope of the present disclosure.

Optionally, the data processing arrangement is operable to store the spatial data pertaining to the portable communication devices. In an example, the spatial data pertaining to a particular portable communication device (such as the device 106) may include an ID (such as MAC address), and the ID of that particular portable communication device associated with retail contexts assigned to the zones visited by that particular portable communication device, and customer dwell-times at the zones. Further, the association of IDs of the portable communication devices with retail contexts of the zones is done in sequences. This enables in determining paths (such as shopping paths) for the portable communication devices in the retail premises.

The concept of dwell-time should be understood as a data set comprising information on where, when and how long a portable communication device is tracked by the wireless communication network.

The paths of the portable communication devices accordingly are based on the movement of the consumers with respect to the various zones of the retail premises. In other words, the paths are associated with the zones visited by the consumers for buying or seeing the products available in such zones. Further, the time spent by the consumers during their visits to such zones also forms a part of such paths. As mentioned above, the each of the plurality of zones is associated with a retail context, therefore the paths becomes a function of retail contexts of the zones visited by the consumers in sequence. It is to be understood that the identification of sequences is based on the spatial positions and dwell-time of the portable communication devices. Specifically, the change in the spatial positions with respect to the dwell-times defines the sequences in which the zones are visited by the consumers. Further, the paths traversed (or followed) by the consumers may be based on shopping behaviors of the consumers, which may be further influenced by various factors including but not limited to gender, age, interests, race, religion and geographical location of residence.

As depicted using arrows, the customer 108, particularly the portable communication device 106 associated therewith, first visits the zone 102c, which caters to the retail category “Vegetables”. Next, the customer 108 visits the zone 102b, which caters to the retail category “Men's clothing”. The customer 108 then visits the zone 102d, which caters to the retail category “Shoes”, before exiting the retail premises 100. Therefore, the arrows depicting movement pattern of the customer 108 with respect to the zones 102 represent a path 120 of the portable communication device 106 in the of the retail premises 100.

According to an embodiment, a path of a given portable communication device (such as the device 106) is associated with an ID of the portable communication device. Further, while determining the paths, the IDs relate to only the portable communication devices and not to the customers carrying the portable communication devices, therefore information for the paths are collected anonymously.

According to an embodiment, for a given portable communication device (such as the device 106), each time the given portable communication device visits a particular zone, a value for a retail context associated with that particular zone is increased. The increase in the value for the retail context accordingly may be reflected in a path of the given portable communication device.

In one embodiment, the retail contexts of zones are associated with counters, which increases when each time a given portable communication device revisits a particular zone. In an example, the counter comprises at least one visiting frequencies and dwell-times of the portable communication devices. The term “visiting frequencies” generally refers to a number of times a particular customer visits a particular zone within the retail premises. Further, the term “dwell-times” generally refers to a time duration for which a particular customer dwelled within a particular zone within the retail premises. Therefore, each time a given portable communication device revisits a particular zone, a counter for a retail context of that particular zone is increased, for example the visiting frequencies may be increased by numbers of subsequent revisits, whereas the dwell-times may be increased with time for subsequent revisits.

As shown in FIG. 1, the path 120 of the portable communication device 106 within the retail premises 100 is determined by identifying a sequence in which 102b, 102c and 102d were visited by the customer 108. The identification of the sequence is performed by associating the special position and the dwell-time of the portable communication device 106 with the retail contexts of the zones 102b, 102c and 102d. The path 120 accordingly includes the retail contexts of the zones 102b, 102c and 102d visited by the portable communication device 106, and counters (or values) for the retail contexts, as shown in a table below.

An example of counters associated with retail contexts of a path (such as the path 120) is provided in the table below. Specifically, the counters associated with retail contexts of the path 120 are based on a single visit of the portable communication device 106 to the retail premises 100.

| | ID | | | |
|---|---|---|---|---|
| | | Men's | | |
| | Electronics | clothing | Vegetables | Shoes |
| 00:00:00:00:00:01 | 0 | 1 | 1 | 1 |
| Dwell total (sec) | 0 | 60 | 60 | 50 |

In this manner, a path for a given portable communication device may be determined and stored by the data processing arrangement. Similarly, paths for a plurality of portable communication devices associated with consumers in a retail premises may be determined and stored by the data processing arrangement.

Further, as mentioned above, the counter of the retail contexts of the paths changes with subsequent visits of the portable communication devices to the zones in the retail premises. According to an embodiment, the subsequent visits include visits made by a given portable communication device to a zone in a same trip of a consumer to a retail premises. Alternatively, the subsequent visits include visits made by a given portable communication device to a zone in next trips of the consumer to the retail premises. Therefore, based on next (or new) trips the consumer may take or follow different paths. Accordingly, new retail contexts may be added to the paths based on new visits of the portable communication devices to new zones of the plurality of zones. Further, counters associated with retail contexts also change with the paths.

Below is a table showing counters associated with retail contexts of accumulated paths (the earlier path 120 and a new path) of the customer 108 with his subsequent trip to the retail premises 100.

| | ID | | | | |
|---|---|---|---|---|---|
| | | Men's | | | |
| | Electronics | clothing | Vegetables | Shoes | Misc. |
| 00:00:00:00:00:01 | 1 | 2 | 2 | 2 | 0 |
| Dwell total (sec) | 60 | 130 | 180 | 150 | 0 |

As shown, the accumulated paths for the customer 108 includes a new retail context “Electronics” having the counters, i.e. visiting frequency as 1 and dwell time as 60 sec. Further, the counters for earlier retail contexts of the accumulated paths also changes, for example, the retail contexts “Men's clothing”, “Vegetables” and “Shoes” as shown to have, i.e. visiting frequencies as 2 and dwell times 130, 180 and 150 sec, respectively. Similarly, paths for a plurality of portable communication devices associated with consumers in a retail premises may be accumulated and stored by the data processing arrangement.

In the table above, a retail category “Misc” may, for example, pertain to a cash register within the retail premises 100. This potentially enables the data processing arrangement to collect information about a number of times a given customer has paid at the cash register, namely a visiting frequency at the cash register. This is particularly advantageous when distinguishing between a good customer and a bad customer. The term “good customer” generally refers to a customer who has a high potential of making a purchase at the retail premises 100, while the term “bad customer” generally refers to a customer who has a low potential of making a purchase at the retail premises 100. As an example, for a customer ‘X’ who has visited the retail premises 100 more than 500 times, but has visited the cash register only 5 times, it can be concluded that the customer ‘X’ is a bad customer.

Another advantage of using the cash register as a retail category is that it is possible to determine one or more days of a week, one or more weeks of a month and/or one or more months when the retail premises 100 has a higher visiting frequency for the cash register, namely has a higher number of good customers.

FIG. 1 is a mere example, which should not unduly limit the scope of the present disclosure. It is to be understood that the illustration of the retail premises 100 is provided as an example and is not limited to a specific number and/or arrangement of zones. A person skilled in the art will recognize many variations, alternatives, and modifications of embodiments of the present disclosure. For example, retail premises 100 can be implemented as an “open plan” environment wherein consumers are able to move from one boutique to another without being aware of boundaries between the boutiques, namely having an impression of a continuum of retailing space.

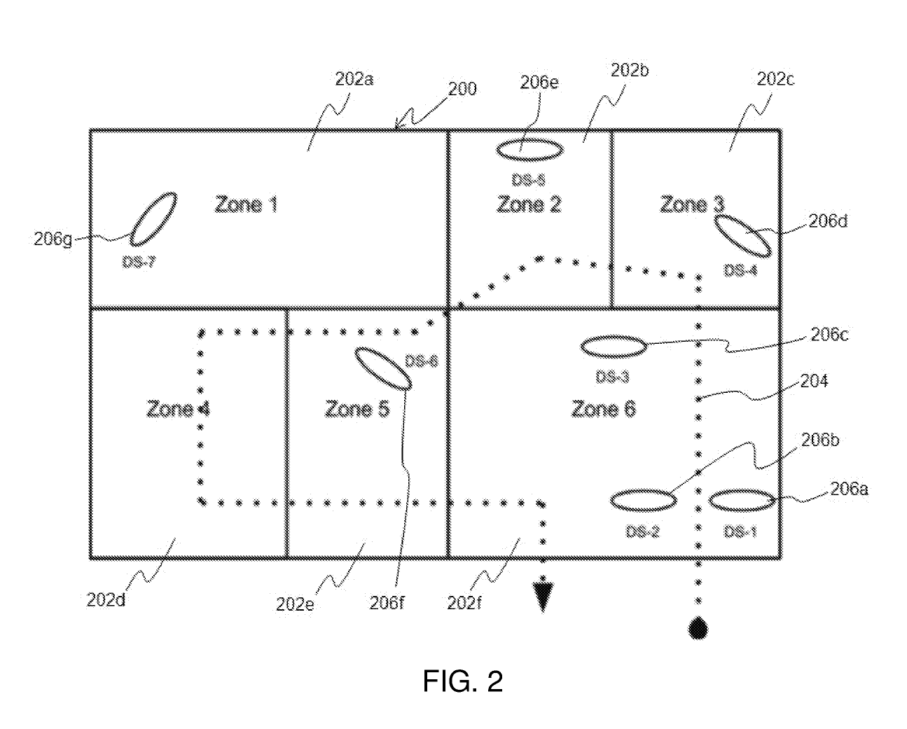

Referring now to FIG. 2, illustrated is another example of a retail premise 200 (different from the retail premises 100 of FIG. 1) that is suitable for practicing another embodiment of the present disclosure. As shown, the retail premises 200 includes a plurality of zones, such as zones 202a, 202b, 202c, 202d, 202e and 202f (hereinafter collectively referred to as zones 202). Further, shown in a path 204 followed by a portable communication device (not shown). Specifically, the portable communication device's movement begins with zone 202f, then followed by the zones 202c, 202b, 202e, 202d, 202e and ends with the zone 202f. Therefore, the path 204 includes a sequence in which zones (202f, 202c, 202b, 202e, 202d, 202e and 202f) are visited by the portable communication device. Accordingly, the path 204 is defined based on the retail context of the zones (202b, 202c, 202d, 202e and 202f) visited by the portable communication device. It is to be understood that, the zones 202 may be associated with retail contexts, such as Electronics, Men's clothing, Vegetables, Shoes, Women's clothing and the like. Also, the path 204 includes counters for the retail contexts of the zones (202b, 202c, 202d, 202e and 202f) visited by the portable communication device, shown with an example table below.

| | | | Zone | Zone | Zone | Zone | Zone |
|---|---|---|---|---|---|---|---|
| | Zone 6, | Zone 3, | 2, | 5, | 4, | 5, | 6, |
| ID | 202f | 202c | 202b | 202e | 202d | 202e | 202f |
| 00:00:00:00:00:02 | 1 | 1 | 1 | 1 | 1 | 1 | 1 |
| Dwell total (sec) | 90 | 40 | 50 | 300 | 600 | 40 | 250 |

The table above depicts information for the path 204 in which the zones 202e, 202f are revisited in a same trip by the portable communication device to the retail premises 200. The counter associated with the retail contexts of the revisited zones 202e and 202f changes accordingly, which may be reflected when the counter for the path 204 is summarized, as shown in the table below.

| | ID | | | | |
|---|---|---|---|---|---|
| | Zone 2, | Zone 3, | Zone 4, | Zone 5, | Zone 6, |
| | 202b | 202c | 202d | 202e | 202f |
| 00:00:00:00:00:02 | 1 | 1 | 1 | 2 | 2 |
| Dwell total (sec) | 50 | 40 | 600 | 340 | 340 |

As shown, the counter associated with the retail contexts of the revisited zones 202e and 202f changes, particularly, a visiting frequency is changed to 2 and a dwell time is accumulated as 340 sec for both zones. Therefore, the path 204 with above counters (or information) is saved for further analysis by the data processing arrangement. Further, the path 204 is saved with a corresponding ID, such as a MAC address, of a portable communication device carried by a consumer following the path 204 in the retail premises 200. Similarly, paths for other portable communication devices making trip to the retail premise 200 are saved for further analysis by the data processing arrangement.

Further, based on the changed retail contexts of the paths a probable path is determined for a maximum number of currently active portable communication devices in the retail premises. For example, the data processing arrangement is operable to analyze saved information associated with the paths of portable communication devices present in a retail premise, such as the retail premise 200, for determining the probable path. Specifically, the saved information associated with the paths is analyzed to determine the probable path, which may be followed by a maximum number currently active portable communication devices present in the retail premise. In an example, the probable path is based on a path that is likely to be taken by the maximum number currently active portable communication devices present in the retail premise. Further, the probable path may change based on type and number of currently active portable communication devices and dwell-time thereof. For example, the probable paths for currently active portable communication devices may be different in morning as compared to noon or evening or night. As shown above, a probable path for a communication device (having ID as 00:00:00:00:00:02) for its subsequent visit would be based on the information (or values) depicted on the above table.

Moreover, the data processing arrangement is operable to select advertisement to be displayed, via at least one of the plurality of digital signages, such as signages 206a, 206b, 206c, 206d, 206e, 206f and 206g, arranged in various locations in the zones 202 of the retail premises 200. Specifically, the data processing arrangement is operable to select advertisement to be displayed based on change in counter of the retail contexts of the paths. In an example, the selected advertisement to be displayed is based on the probable path of the currently active portable communication devices present in the retail premise. Further, based on the changed retail contexts of the paths the advertisement to be displayed may be altered, which will be explained in greater detail in conjunction with subsequent figures.

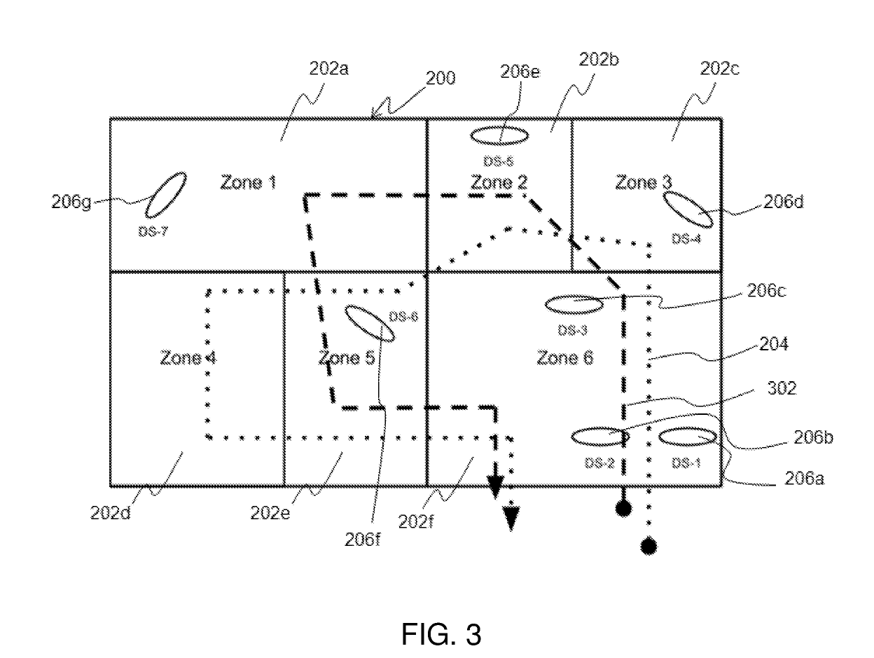

Referring now to FIG. 3, illustrated is the retail premise 200 that is suitable for practicing yet another embodiment of the present disclosure. As shown, the retail premise 200 includes the zones 202. Further, shown are the path 204 and a path 302 followed by communication devices. Specifically, the paths 204, 302 may be probable paths to be followed by currently active portable communication devices (not shown) in different dwell-time (for example, the path may be the path 204 associated with morning and the path 302 may be associated with noon).

As shown, the path 204 includes a sequence in which zones (202f, 202c, 202b, 202e, 202d, 202e and 202f) are visited by the portable communication devices. Accordingly, the path 204 is defined based on the retail context of the zones (202f, 202c, 202b, 202e, 202d, 202e and 202f). Similarly, the path 302 includes a sequence in which zones (202f, 202c, 202b, 202a, 202e and 202f) are visited by the portable communication devices. Accordingly, the path 302 is defined based on the retail context of the zones (202f, 202c, 202b, 202a, 202e and 202f). Further, based on above, the advertisement to be displayed, via at least one of a plurality of digital signages 206a-g (arranged in the retail premises 200), is selected based on change in counter of the retail contexts of the paths 204, 302. Further, the advertisement is altered based on the changed retail contexts of the paths 204, 302 of the currently active portable communication devices in the retail premises 200.

In an embodiment, the present disclosure also enables in determining a price for selected advertisement to be displayed. The price for the selected advertisement is determined based on calculating an automated rate card weighting scheme. Specifically, the automated rate card weighting scheme is calculated to determine which digital signage will show what advertisement and when, based on the probable path of the maximum number of currently active portable communication devices present in the retail premises 200. For example, based on the probable path, consumers' response towards the presented advertisement may be analyzed, and accordingly shop-owners (associated with various zones 202) may be requested to pay for showing the advertisement associated with their retail context in various zones 202. Therefore, based on the determined price a time period and a digital signage (present in the retail premises 200) are selected for displaying the selected advertisement.

In an embodiment, the weight (to determine which digital signage will show what advertisement and when) is a float value between 0.0-1.0. Further, the higher the number, the higher the probability of the advertisement being relevant, which is explained in conjunction table below:

| Date | Dec. 9, 2015 | | | | |
|---|---|---|---|---|---|
| Location | 09:00-10:00 | 10:00-11:00 | 11:00-12:00 | 12:00-13:00 | 13:00-14:00 |
| DS - 1 | 0.2 | 0.2 | 0.2 | 0.2 | 0.2 |
| DS - 2 | 0.2 | 0.2 | 0.2 | 0.2 | 0.2 |
| DS - 3 | 0.4 | 0.4 | 0.4 | 0.4 | 0.2 |
| DS - 4 | 0.5 | 0.5 | 0.5 | 0.5 | 0.2 |
| DS - 5 | 0.9 | 0.9 | 0.9 | 0.9 | 0.5 |
| DS - 6 | 0.7 | 0.7 | 0.7 | 0.7 | 0.5 |
| DS - 7 | 0.1 | 0.1 | 0.1 | 0.1 | 0.9 |

As shown, the table shows an automated rate card for a day, (for example, Sep. 12, 2015) associated with a retail context, such as baby food. In an example, the baby food section may be located in the zone 202e. Further, the paths 204, 302 may be probable paths for the maximum number of currently active portable communication devices in the retail premises 200 during different time frames, which may be associated with the calculated weights.

As shown above, the weights of 0.9 with respect to digital signage 206e (i.e. DS-5), depicts the best times (i.e. 09:00 a.m.-13:00 p.m) for showing the advertisement content associated with baby food in the digital signage 206e. Specifically, based on the path 204 the currently active portable communication devices may visit the zone 202e after zone 202b (having the digital signage 206e), therefore the digital signage 206e may be presented with baby food product advertisement (which is the retail context the zone 202e). Further, the best times may be 09:00 a.m.-13:00 p.m may be associated with the weights, which is determined based on shoppers' movement between the different zones and how long they dwell in each zone (i.e. stored paths of the shoppers). In other words, the weights may be calculated by an algorithm based on change in counter of the retail contexts of the paths 204 and 302. As mentioned above, the counter comprises at least one of visiting frequency and dwell-time of the portable communication devices. Therefore, a very low dwell time in a zone may signify that the customers are passing very quickly from that zone, and a longer dwell time may signify that the customers have more time to look at a digital signage. The visiting frequency may be considered in a similar manner. Accordingly, the algorithm enables in presenting the digital signages (that appear just before the customers entering any zones) with advertising content based on the weights, i.e. the visiting frequency and dwell-time of the portable communication devices. Further, based on the path 302 the currently active portable communication devices may visit the zone 202e after zone 202a (having the digital signage 206g), therefore the digital signage 206g may be presented with baby food product advertisement (which is the retail context the zone 202e). Further, the best times may be after 13:00 p.m, based on the measured weights.

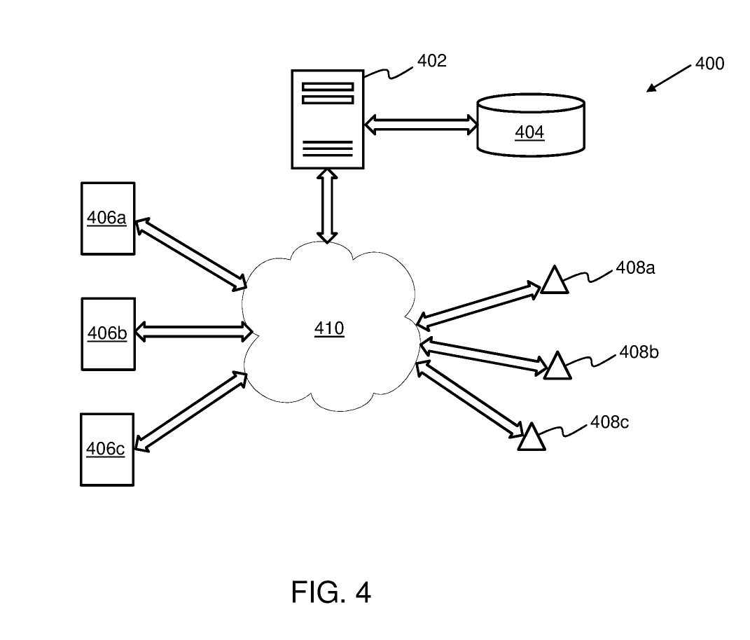

Referring now to FIG. 4, illustrated is a schematic illustration of a system 400 for providing targeted advertising within a retail premises, such as retail premises 100, 200 of FIGS. 1, 2 and 3, in accordance with an embodiment of the present disclosure. The system 400 includes, but is not limited to, a data processing arrangement 402, a database 404, a plurality of digital signage 406a, 406b, and 406c (hereinafter collectively referred to as digital signage 406), and a plurality of wireless apparatuses 408a, 408b, and 408c (hereinafter collectively referred to as wireless apparatuses 408).

The data processing arrangement 402 is communicably coupled to the digital signage 406 and the wireless apparatuses 408, via a communication network 410. The communication network 410 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

The digital signage 406 are physically arranged (or installed) at various spatial locations within the retail premises (not shown). As described earlier, the retail premise is partitioned into a plurality of zones, and each of which is associated with a corresponding retail context.

The data processing arrangement 402 is operable to determine paths of the portable communication devices within the retail premises and select advertisement to be displayed, via at least one of the digital signages 406, based on change in counter of the retail contexts of the paths.

The data processing arrangement 402 is operable to determine (or collect) paths of the portable communication devices, having a unique identity such as a MAC address, in the retail premises. The data processing arrangement 402 is further operable to store data pertaining to the paths of portable communication devices at the database 404 with corresponding MAC addresses.

According to an embodiment, the data processing arrangement 402 is operable to provide a service that allows its users to access the data stored at the database 404. In an example, the service could be a web-based service. Users of such a service could, for example, be retail store owners who are interested in understanding customer behavior (particularly, tentative or probable path that may be taken by customers of a particular zone), and possibly optimizing advertisement of that zone based on the probable path of the customers to increase sales based on such targeted advertising.

The data processing arrangement 402 is operable to aggregate the data stored at the database 404, namely the data (i.e. counters) pertaining to the retail contexts of the path to provide meaningful insights to customer behavior. In an embodiment, aggregation may be done by using k-means clustering algorithms.

It is to be noted here that the data may be aggregated in various ways depending on application-specific requirements. In an example, the data is aggregated only for active customers, namely for portable communication devices that are active within a zone of the retail premises currently. This provides valuable insights about currently active customers.

According to an embodiment, the data processing arrangement 402 is operable to select at least one zone of the retail premises, particularly, data of stored paths of the currently active customers of that zone. For example, data includes counters, i.e. visiting frequencies and dwell time, of retail contexts of the paths. Therefore, based on the counters of the paths, a tentative or a probable path that may be taken by a maximum number of currently active customers of that zone may be determined. For example, if a zone A has 100 currently active customers, and among that 100 customers, the database 404 of the system 400 has previously stored paths (particularly, data i.e. counters of retail contexts) for 80 currently active customers. Further, among 80 currently active customers, 50 customers have counter (visiting frequencies and/or dwell time) indicating that these 50 customers may visit zone B after zone A. In such instance, a digital signage arranged in the zone A may be displayed with advertisement related to retail context of the zone B. If we read this example in conjunction with FIG. 2, when zone 202f has maximum number of currently active customers that may visit zone 202c, then one of the digital signages 206a, 206b and 206c of the zone 202f may be presented (or displayed) with the advertisement related to a retail context of the zone 202c. Similarly, probable paths for maximum number of currently active customers in the various zones may be determined for presenting targeted advertisement in such zones.

For this purpose, a plurality of advertisements related to various retail contexts is stored at the database 404 or another database. Optionally, the data processing arrangement 402 is operable to fetch one or more advertisements related to the at least one retail context from the database 404, and send the one or more advertisements to the one or more of the digital signage 406 for display. As an example, the digital signage 406 can be used to present promotions, inform about products, services and guide customers within the retail premises.

In this manner, the system 400 is operable to provide the targeted advertising in an automated manner Beneficially, the system 400 is operable to provide the targeted advertising in real time.

In one embodiment, the system 400 is operable to facilitate Real-Time Bidding (RTB) of advertisements. In this regard, the system 400 can be employed to sell rights to display information on the digital signage 406 to one or more advertisers who have won a bid.

In an additional embodiment, the system 400 is operable to employ a business model, where advertisers pay to know trends and patterns in customer behavior within the retail premises. Further, based on the identified trends and patterns in customer behavior within the retail premises, shop-owners (associated with various zones) may be requested to pay for showing the advertisement associated with their retail context in various zones in the retail premise. Specifically, as explained above, the data processing arrangement is further operable to determine pricing for the selected advertisement to be displayed. Further, based on the determined price a time period and a digital signage, from the plurality of digital signages, is selected for displaying the selected advertisement. For example, as mentioned above, the data processing arrangement may be operable to calculate an automated rate card weighting scheme for determining the pricing for the selected advertisement to be displayed.

FIG. 4 is merely an example, which should not unduly limit the scope of the present disclosure. It is to be understood that the illustration of the system 300 is provided as an example and is not limited to a specific number and/or arrangement of data processing arrangements, databases and digital signage. A person skilled in the art will recognize many variations, alternatives, and modifications of embodiments of the present disclosure. For example, the system 400 may be implemented to simultaneously accommodate a plurality of retail premises.

In an alternative implementation of the system 400, the data processing arrangement 402 is operable to send the aggregated data of paths to a third party server. In this implementation, the third party server is then operable to provide the targeted advertising via the digital signage 406.

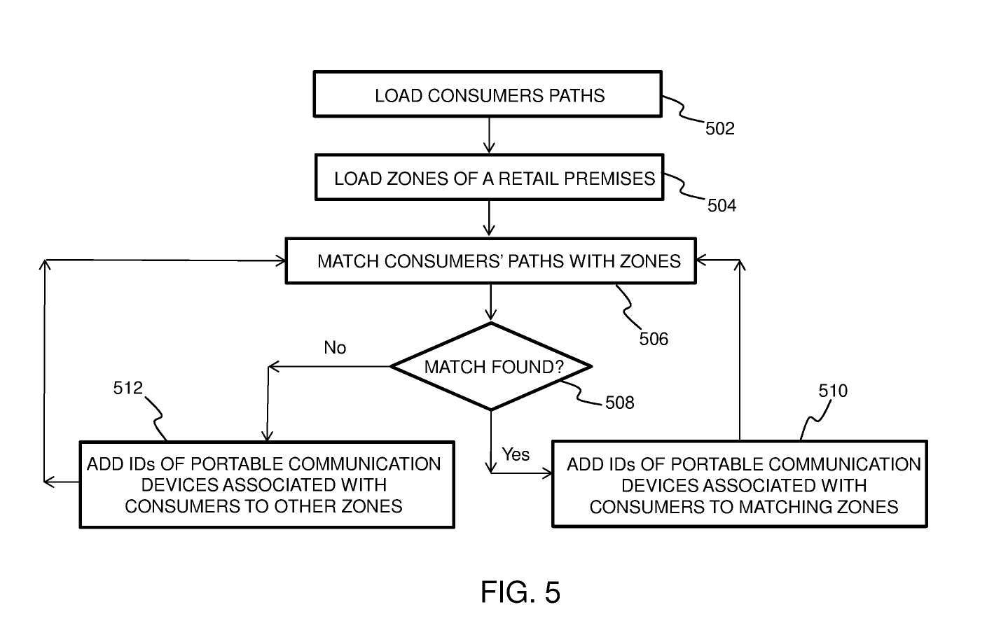

FIG. 5 is a flow chart depicting steps of a method 500 for determining in real time a probable path for a maximum number of currently active customers in zones of a retail premises, in accordance with an embodiment of the present disclosure.

At step 502, the consumer paths are loaded. In an example, the data processing arrangement is operable to collect the paths for active customers in a retail premises.

At step 504, the zones of the retail premises are loaded. In an example, the data processing arrangement is operable to collect data about various zones present in the retail premises.

At step 506, consumers' paths are matched with zones. In an example, the data processing arrangement is operable to match the consumers' paths for the active customers with respect to the zones present in the retail premises.

At step 508, match between the consumers' paths and zones are found. In an example, the match between the consumers' paths and zones may be found by matching their retail contexts.

At step 510, if the match is found, IDs of portable communication devices associated with consumers are added to the matching zones. Therefore, based on number of the IDs and the matching zones, a probable path for a maximum number of currently active customers for a particular zone with respect to another zone may be determined. Accordingly, based on the probable path, targeted advertising may be presented in the particular zone with respect to another zone.

At step 512, if the match is not found, IDs of portable communication devices associated with consumers are added to other zones.

FIG. 5 is merely an example, which should not unduly limit the scope of the present disclosure. A person skilled in the art will recognize many variations, alternatives, and modifications of embodiments of the present disclosure.

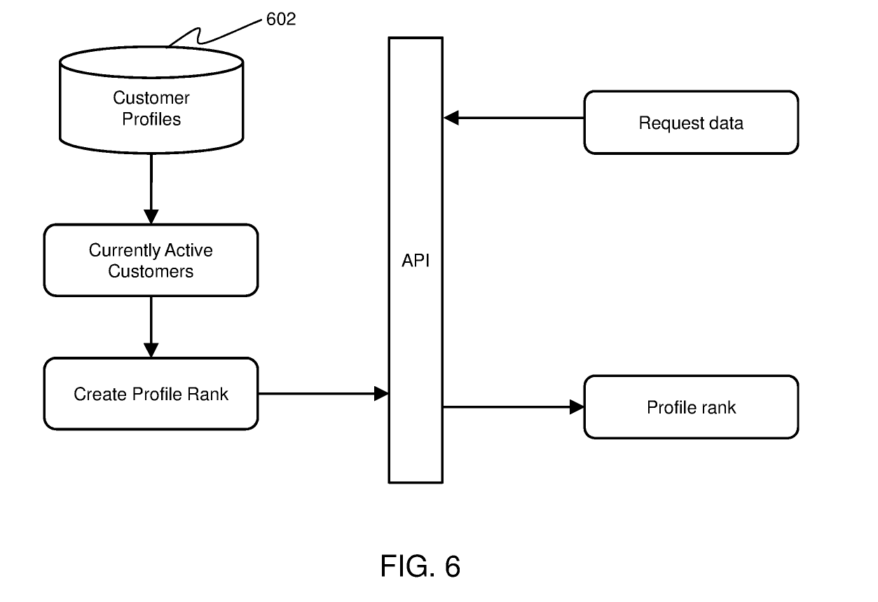

FIG. 6 is a schematic illustration of an example Application Programming Interface (API), in accordance with an embodiment of the present disclosure. In FIG. 6, there is shown a database 602 that stores customer profiles for at least one retailing premises. The term “customer profiles” generally refers to data pertaining to paths (i.e. counters for retail contexts) for a plurality of customers of various retail premises.

For illustration purposes only, there will now be considered an example where a client sends a request for a profile rank for a given retailing premises. The term “profile rank” generally refers to a tentative path that may be taken by a plurality of customers of that retail premises.

Optionally, the API allows the client to request the profile rank for only a given zone, instead of all zones in the given retail premises.

In the example, it is considered that the client is interested in knowing the profile rank with respect to customers who are currently active within the given zone.

Accordingly, customer profiles of the currently active customers are fetched from the database 602.

Subsequently, the profile rank for the given zone is created by aggregating the fetched customer profiles. The profile rank is then sent to the client.

FIG. 6 is merely an example, which should not unduly limit the scope of the present disclosure. A person skilled in the art will recognize many variations, alternatives, and modifications of embodiments of the present disclosure.

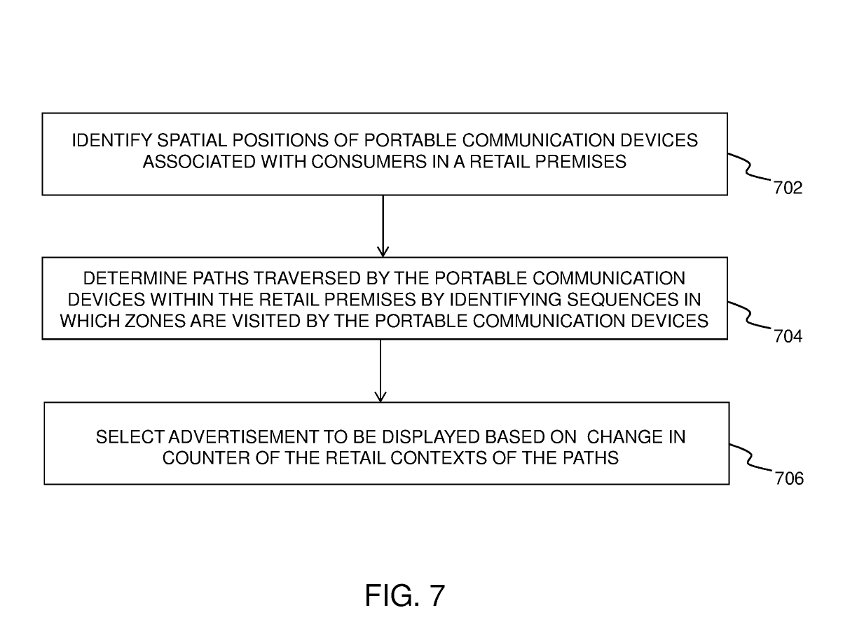

FIG. 7 is an illustration of steps of a method 700 for providing targeted advertising within a retail premises having a plurality of zones, in accordance with an embodiment of the present disclosure. Further, each of the plurality of zones is associated with a retail context. The method 700 is depicted as a collection of steps in a logical flow diagram, which represents a sequence of steps that can be implemented in hardware, software, or a combination thereof.

At step 702, spatial positions of portable communication devices associated with consumers is identified in the retail premises.

At step 704, paths traversed by the portable communication devices within the retail premises are determined by identifying sequences in which zones are visited by the portable communication devices. The paths include retail contexts of the zones visited by the portable communication devices.

At step 706, advertisement to be displayed, via at least one of a plurality of digital signages arranged in the retail premises, is selected based on change in counter of the retail contexts of the paths.

It should be noted here that the steps 702 to 706 are only illustrative and other alternatives can also be provided where one or more steps are added, one or more steps are removed, or one or more steps are provided in a different sequence without departing from the scope of the claims herein. For example, the method 700 further comprise altering the advertisement based on changed in retail contexts of the paths of the portable communication devices in the retail premises. Specifically, the counter of the retail contexts of the paths changes with subsequent visits of the portable communication devices to the zones in the retail premises. In an example, the counter comprises at least one of visiting frequencies and dwell-times of the portable communication devices. Further, the retail contexts comprise one of a product category and a brand of a product. The method 700 also comprises adding new retail contexts to the paths based on new visits of the portable communication devices to new zones of the plurality of zones. The method 700 also comprises determining price for selected advertisement to be displayed. Further, based on the determined price a time period and a digital signage, present in the retail premises, is selected for displaying the selected advertisement.

The present disclosure also seeks to provide a computer program product for providing targeted advertising within a retail premises having a plurality of zones. Specifically, embodiments of the present disclosure provide a computer program product comprising a non-transitory computer-readable data storage medium having stored thereon computer-readable program code, which is executable by a processor of a computing device to implement the aforementioned method 700.

Embodiments of the present disclosure are susceptible to being used for various purposes, including, though not limited to, enabling retail store owners to understand customer behavior, and facilitating targeted advertising in real time. The present disclosure provides ability to attach a visit history to an anonymous identifier and use that information to improve targeted advertising. Based on the present disclosure, a real time advertisement bidding system may be offered to sell right to display advertisement on a network of digital signage or to simply pay to know what kind of customer behaviors is largely represented in real time. For example, to determine a probable path that may be taken by a maximum number of customers from one zone to another zone in a retail premises. This enables in determining with what brands/products the consumers interact and in what order. Further, measuring the exposure of certain brands/products by analyzing time spent in zones and correlating it with sold merchandise from that zone. Based on the present disclosure, gender assignment may be done based on analyzed behavior, for example Men/Women have a higher chance of a certain path and what is the average error associated with such assignment. Moreover, based on the present disclosure, the consumers may be categorized into groups based on their shopping behavior and tying the groups with the average shopping basket size (for example average money spending capacity). The present disclosure enables in providing targeted advertising, i.e. to present advertisement based on the most effective timing (when), the advertisement (what context) and location (which zone). Also, the present disclosure enables in determining price for the advertisement to be displayed based on consumer's behavior (or effectiveness of targeted advertising).

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A method for providing targeted advertising within a retail premises having a plurality of zones, each of the plurality of zones is associated with a retail context, the method comprising:
identifying spatial positions of at least one portable communication device associated with a consumer in the retail premises;
determining a path traversed by the portable communication device within the retail premises by identifying sequences in which zones are visited by the portable communication device, wherein the identification of sequences is based on the spatial positions and dwell-time of the portable communication device, and wherein the paths include retail contexts of the zones visited by the portable communication device; and
selecting advertisement to be displayed, via at least one of a plurality of digital signages arranged in the retail premises, based on change in counter of the retail context of the path, wherein the counter comprises at least one of visiting frequency and dwell-time of the portable communication device.

2. A method according to claim 1, wherein the counter of the retail contexts of the paths changes with subsequent visits of the portable communication devices to the zones in the retail premises.

3. A method according to claim 2, further comprising altering the advertisement based on the changed retail contexts of the paths of the portable communication devices in the retail premises.

4. A method according to claim 2, wherein the changed retail contexts of the paths provides a probable path for a maximum number of currently active portable communication devices in the retail premises.

5. A method according to claim 1, comprising identifying a plurality of portable communication devices, determining paths traversed by the plurality of portable communication devices and selecting advertisement to be displayed, based on change in counter of the retail contexts of the paths.

6. A method according to claim 1, wherein the retail contexts comprise one of a product category and a brand of a product.

7. A method according to claim 1, further comprising adding new retail contexts to the paths based on new visits of the portable communication devices to new zones of the plurality of zones.

8. A method of claim 1, further comprising determining price for selected advertisement to be displayed.

9. A method of claim 8, wherein based on the determined price a time period and a digital signage, present in the retail premises, is selected for displaying the selected advertisement.

10. A system for providing targeted advertising within a retail premises having a plurality of zones, each of the plurality of zones is associated with a retail context, the system comprising:
a plurality of digital signages arranged in the retail premises;
a plurality of wireless apparatuses for determining spatial positions of portable communication devices associated with consumers in the retail premises; and
a data processing arrangement operable to
determine paths traversed by the portable communication devices within the retail premises by identifying sequences in which zones are visited by the portable communication devices, wherein the identification of sequences is based on the spatial positions and dwell-time of the portable communication devices, and wherein the paths include retail contexts associated with the zones visited by the portable communication devices; and
select advertisement to be displayed, via at least one of the plurality of digital signages, based on change in counter of the retail contexts of the paths and at least one of visiting frequencies and dwell-times of the portable communication devices.

11. A system according to claim 10, wherein the data processing arrangement is further operable to determine pricing for the selected advertisement to be displayed.

12. A system according to claim 11, wherein based on the determined price a time period and a digital signage, from the plurality of digital signages, is selected for displaying the selected advertisement.
